(19) United States
(12) Patent Application Publication
(10) Pub. No.: US 2001/0044293 A1
(43) Pub. Date: Nov. 22, 2001

(54) SYSTEM AND METHOD FOR GLOBAL REAL-TIME ACCOUNT TRACKING

(76) Inventor: JOSEPH LA MANCE MORGAN, DUBLIN, OH (US)

Correspondence Address: SAMUEL H. DWORETSKY, REG.NO.45,272, AT&T CORP., POST OFFICE BOX 4110, MIDDLETOWN, NJ, 077484801

(21) Appl. No.: 09/201,467

(22) Filed: Nov. 30, 1998

(51) Int. Cl. G06F 17/60; H04M 11/00

(52) U.S. Cl. 455/405; 455/406; 455/407

(57) ABSTRACT

A system and method for providing global real-time account tracking particularly useful in a global telecommunications system includes a plurality of telecommunications switches coupled to distributed account databases located in various locations that are linked together by a plurality of account transfer communications links. The system determines the location of a customer as the customer moves from place to place and automatically transfers the customer's account information to the local account database where the customer is located. A home account database variable stores information as to the current location of the customer's account record. By distributing the account database to each local area serviced by the telecommunications system, and by automatically transferring the account data to the local area where the customer is located, the disadvantages of a centralized account tracking system having dedicated links are overcome.

### BACKGROUND OF THE INVENTION

The present invention relates to the field of real-time account tracking and billing in a global environment. In particular, the preferred embodiment of the present invention provides a novel real-time account tracking system for use with a global pre-paid or post-paid wireless telecommunications network. Other applications for the principles of real-time account tracking are, of course, possible, and are within the scope of the present disclosure.

Presently known real-time account tracking systems for use with wireless (or wireline) telecommunications systems suffer from several major disadvantages. These systems generally employ a single centralized account database for storing customer account information linked to a centralized switching platform for controlling call termination and other services. As long as the customer is located in the same country (or locale) as the centralized account database, the system can easily track the customer's account status in real-time by virtue of the localized connection between the customer and the telecommunications switching platform, which can access the account information in real-time. Extending this localized real-time account tracking system to a global environment creates many problems for the system provider. These problems render the presently known systems costly, difficult to implement, and unreliable to operate.

The primary problem with extending these systems to a global network is the fact that they include the centralized database for storing the customer account. Because of this limitation, if a customer roams to another country (state, province or other non-local area) and tries to use the telecommunications service, then a switching platform in the other country (or location) must be in constant communication with the centralized database in order to properly track the account in realtime. Herein lies the problem. The cost of supporting dedicated links between the centralized database and a plurality of other countries (or locations) is extremely high. This cost disadvantage alone makes these systems presently not useful. In addition, if a failure occurs on the dedicated communication link, or at the central database, then the system won't work. Thus, the reliability of the dedicated link and the robustness of the centralized database are key failure mechanisms in the presently known account tracking systems.

Other disadvantages of the centralized database account tracking systems include: (i) as the size of the central database becomes large (which typically occurs, since it has to hold all of the data for all of the global customers), it becomes slow and cumbersome, and may be more prone to failure, thus causing the entire global system to crash; (ii) because of the threat of a single-point-failure on the centralized database, this component must be engineered for zero-tolerance failure, making it very expensive to construct and administer; (iii) depending on the traffic to and from a particular country, the dedicated link may become overburdened, resulting in undesirable delays or even calls being dropped; and (iv) because of the amount of information required to be transferred from the other countries to the centralized database during the duration of a transaction, wide-bandwidth dedicated links are required, which are correspondingly expensive. In summary, the fundamental problem with these systems is the reliable maintenance of the single centralized database and the plurality of dedicated links, which is a very cost-prohibitive problem.

Thus, there remains a general need in this field for a system and method for global real-time tracking of customer accounts that overcomes the problems associated with the centralized database systems.

### SUMMARY OF THE INVENTION

The present invention overcomes the problems noted above and satisfies the needs in this field for a system and method for providing global real-time account tracking particularly useful in a global telecommunications system. The invention includes a plurality of telecommunications switches coupled to distributed account databases located in various locations that are linked together by a plurality of account transfer communications links. The system determines the location of a customer as the customer moves from place to place and automatically transfers the customer's account information to the local account database where the customer is located. A home account database variable stores information as to the current location of the customer's account record. By distributing the account database to each local area serviced by the telecommunications system, and by automatically transferring the account data to the local area where the customer is located, the disadvantages of a centralized account tracking system having dedicated links are overcome.

One embodiment of the present invention provides a system for global real-time account tracking in a pre-paid telecommunications environment, comprising: a plurality of pre-paid switching platforms located in a plurality of different countries; a plurality of account databases for storing customer account information coupled to the pre-paid switching platforms, wherein each account database serves as a home database for customer's that reside in a particular country; the customer account information including a location flag for indicating the present location of the customer's account information; and a plurality of account transfer communication links for transferring the customer account information from one of the account databases to another.

Another embodiment of the present invention provides a system for real-time account tracking, comprising: a dynamic distributed database system for storing account information, the database system including a plurality of individual databases located in a plurality of geographically dispersed regions, wherein each database serves as a home database for certain accounts; at least one variable entry for each account that indicates the current location of the account in the distributed database system; means for determining whether the account is in the correct database; and means for transferring the account information from one database to another if it is determined that the account is not in the correct database.

A preferred method of the invention provides real-time account tracking in a pre-paid cellular telecommunications system, comprising the steps of providing a dynamic distributed database system for storing account information, the database system including a plurality of individual databases located in a plurality of geographically dispersed regions, wherein each database serves as a home database for certain accounts and includes at least one variable entry for each account that indicates the current location of the account in the distributed database system; determining the location of a pre-paid cellular customer who has an account with the system; determining whether the customer's account is stored in the correct database; and transferring the customer's account information from one database to another if it is determined that the account is not in the correct database.

The present invention provides many advantages over presently known real-time account tracking systems. Not all of these advantages are simultaneously required to practice the invention as claimed, and the following list is merely illustrative of the types of benefits that may be provided, alone or in combination, by the present invention. These advantages include: (1) cost effective implementation; (2) only requires low-bandwidth periodic connections; (3) distributed database architecture is less expensive to maintain, less prone to failure, and faster to operate than the centralized database; (4) eliminates service denials due to failures of the dedicated links and the centralized database; (5) reduces call setup time in the telecommunications implementation; (6) the distributed architecture allows for a degree of global scalability that is not possible in the centralized implementation; and (7) allows monetary exchange rates to be applied upon transfer of the account balance from one location to another.

These are just a few of the many advantages of the present invention, as described in more detail below. As will be appreciated, the invention is capable of other and different embodiments, and its several details are capable of modifications in various respects, all without departing from the spirit of the invention. Accordingly, the drawings and description of the preferred embodiments set forth below are to be regarded as illustrative in nature and not restrictive.

### BRIEF DESCRIPTION OF THE DRAWINGS

The present invention satisfies the general need noted above as will become apparent from the following description when read in conjunction with the accompanying drawings wherein:

FIG. 1 is a system-level block diagram of a preferred embodiment of the present invention setting forth a distributed real-time account tracking system between two countries for a pre-paid wireless communications application;

FIG. 2 is another system-level block diagram of a preferred embodiment of the present invention setting forth a distributed real-time account tracking system between three countries for a pre-paid wireless communications application; and

FIG. 3 is a flow chart of a preferred method of transferring call-setup and account information between the distributed databases shown in FIGS. 1 and 2 for the pre-paid wireless communications application.

### DETAILED DESCRIPTION OF THE DRAWINGS

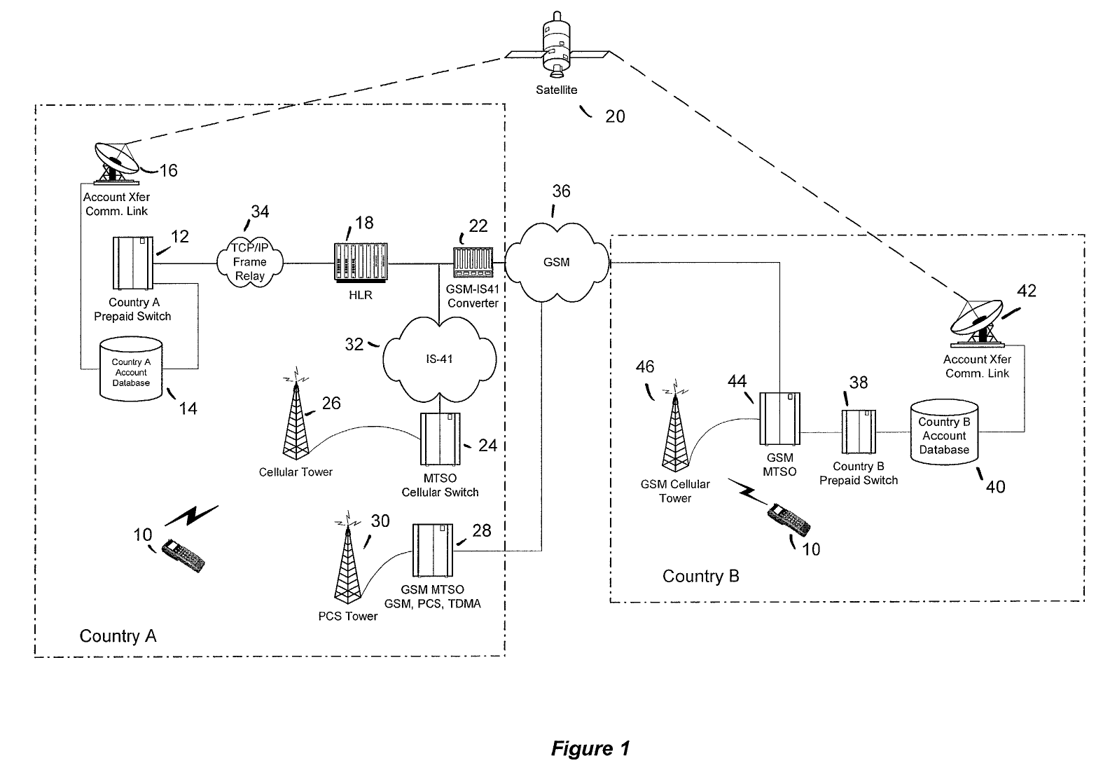

Referring now to the drawings, FIG. 1 is a system-level block diagram of a preferred embodiment of the present invention setting forth a distributed real-time account tracking system between two countries (Country A and Country B) for a pre-paid wireless communications application. Although the example real-time account tracking system shown in FIG. 1 is a pre-paid wireless communications system, the scope of the present invention is not limited to any particular application, and may extend to other types of services, such as post-paid wireless telecommunications systems, pre-paid or post-paid wireline services, or other types of systems that require real-time account tracking as a customer moves from place to place.

FIG. 1 shows two countries, Country A and Country B, which could be located close to each other, such as the United States and Canada, or which could be geographically dispersed, such as the United States and Germany. For purposes of explaining the invention, it will be assumed that Country A is the United States and Country B is Germany, although this is arbitrary. In each country, an existing cellular communications system (or systems) exist. These systems could be traditional analog cellular, such as AMPS, or could be more modern digital cellular systems, such as PCS, GSM or TDMA systems, to name a few.

Each cellular system consists of a plurality of cellular radio towers 26, 30, 46, which are coupled to one or more Mobile Telephone Switching Offices (or “MTSOs”) 24, 28, 44. These elements are well-known in the cellular art, and thus will not be described herein in detail. The MTSOs are, in turn, coupled to each other, and to a plurality of devices known as Home Location Registers (HLRs) through one or more network clouds 32, 36. The HLRs store security, service and configuration information for every valid customer in the particular cellular network served by the local MTSO.

In the example of FIG. 1, Country A includes two cellular systems, an analog system and a digital system. The analog system includes a plurality of cellular towers 26 and one or more analog MTSOs 24. In the typical analog cellular system, such as AMPS, the MTSOs and HLRs are coupled via a standard interface known as IS-41 32. The serving MTSO (i.e., the MTSO serving the roaming customer 10 uses IS-41 signaling to obtain information on roaming subscribers from their profile stored in the home HLR for the particular customer. A copy of the subscriber's profile from the HLR for that subscriber is then temporarily stored in the serving MTSO's foreign VLR (“Visitor Location Register”). The digital system, represented in Country A by a plurality of towers 30 and one or more MTSOs 28, could be a GSM system (which is a widely adopted standard in Europe and elsewhere), a PCS system, or a digital TDMA system. These digital cellular MTSOs communicate in the same manner as, but over a different standard interface than the analog systems to exchange customer information, which is shown as a GSM cloud 36 in the figure. FIG. 1 also shows a GSM-to-IS-41 converter 22, which is a device that simply converts GSM signaling to the IS-41 standard, so that the system can use a single HLR 18, which can then communicate to both IS-41 MTSOs 24 and GSM MTSOs 28, 44.

The pre-paid telecommunications system is shown as elements 12, 14 and 16 in Country A, and elements 38, 40 and 42 in Country B. These systems are linked together via satellite connection 20, which could, alternatively, be any other type of high or low bandwidth wireless or wireline connection. As will be discussed in more detail below, the ability to link the distributed database system together with a simple low bandwidth connection 20 is a major advantage of the present invention over presently known real-time account tracking systems that use the centralized database approach.

In Country A, the pre-paid switching platform 12, which is coupled to the MTSOs 24, 28 through the public-switched telephone network (“PSTN”), is also coupled to the HLR 18 for the system by some type of dedicated network 34, which could be a TI line, an Internet connection, an ATM connection, frame-relay, or any other type of link. Also coupled to the pre-paid platform 12 is the customer account database for Country A 14 and an account transfer communication link 16, which is shown as a satellite connection, but as noted could be any other type of high or low bandwidth link, and preferably is not a dedicated link as in the prior centralized database systems. The Country A database 14 is preferably the “home” database for customers that reside in Country A, or which primarily communicate using the system when in Country A.

Country B includes the same equipment as Country A, i.e., existing cellular network 36, 44, 46, pre-paid switching platform 38, and account transfer communications link 42, except that it has its own home database 40 for storing customer account information. The Country B database is primarily used for storing account information for customers who reside in Country B, although, as described below, the distributed database system (consisting of at least two databases) is dynamic in the sense that customer account data can be readily transferred from one database to another depending on the present location of the customer 10. This distributed database element for effecting low-cost, real-time account tracking provides one major advantage of the present invention over the centralized database systems.

Each of the distributed databases 14, 40 stores account information for customers 10. This information may include the Mobile Identification Number (“MIN”) and Electronic Serial Number (“ESN”) of the customer's mobile phone, a PIN code for account validation, the phone number of the mobile phone, an account number, and the amount of time (or money) or some other account variable associated with the account that is tracked on a real-time basis. In addition, the account information may include configuration information regarding whether the customer 10 has paging services, voice-mail, or other telephony functions that may have been assigned to this particular customer account. Note that although the preferred embodiment is directed to account tracking in a pre-paid wireless system, the invention is not limited to this application, and for other applications, such as post-paid wireless, pre-paid or post-paid wireline, or other telecommunications or non-telecommunications applications, the account data stored in the distributed databases could be different.

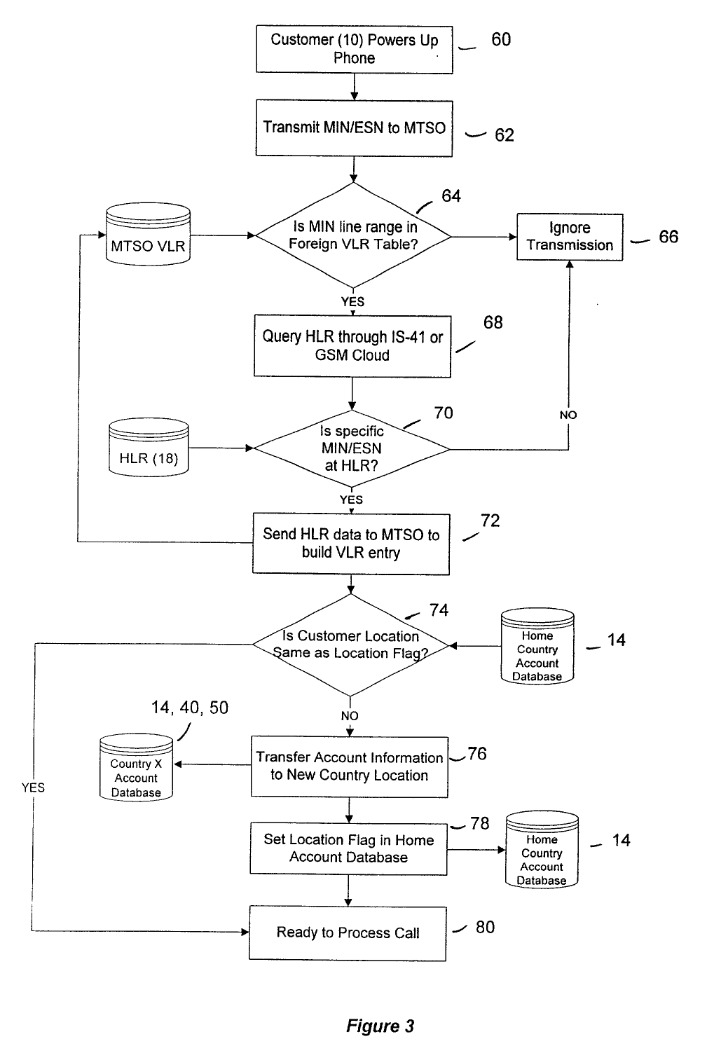

Furthermore, each customer's 10 home database account includes a variable entry known as the Location Flag. This variable indicates the current physical location of the customer 10, i.e., is the customer 10 in Country A or Country B, or somewhere else. As described below in connection with FIG. 3, the Location Flag information is used by the system to determine how to transfer the customer's 10 account record when the customer 10 moves from location to location.

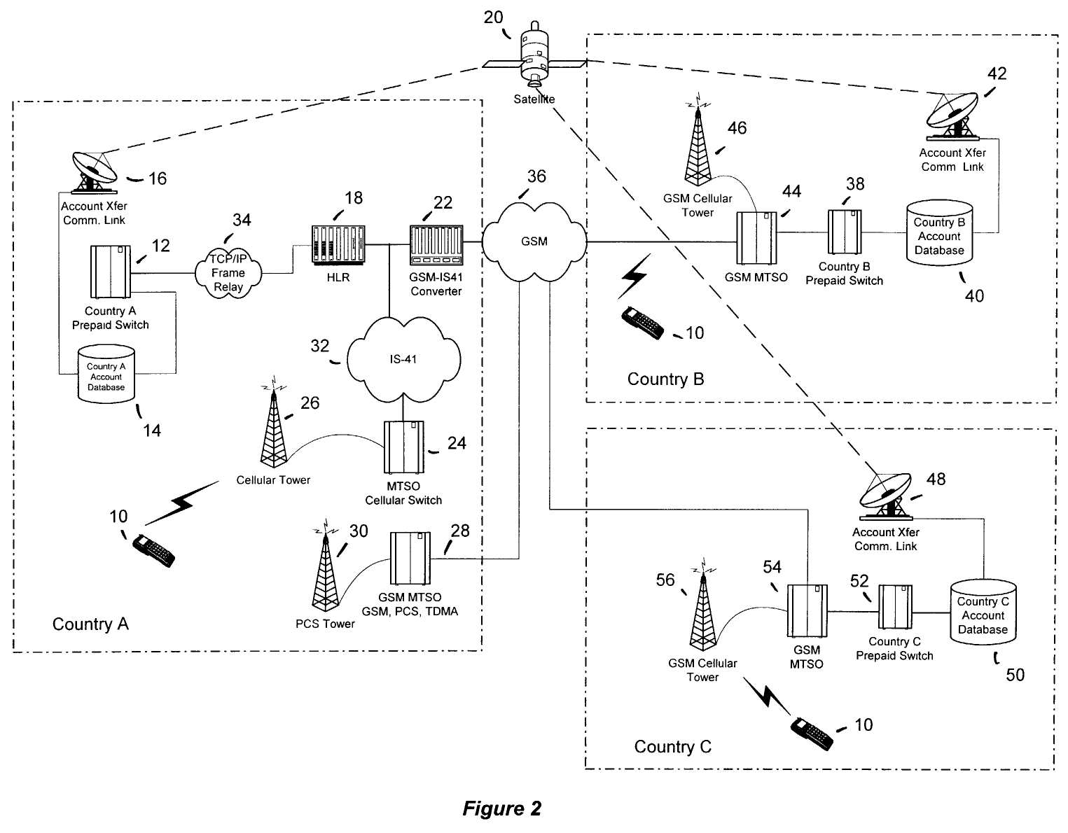

FIG. 2 is another system-level block diagram of a preferred embodiment of the present invention setting forth a distributed real-time account tracking system between three countries for a pre-paid wireless communications system. This system will not be described in detail, as it includes the same elements as FIG. 1, with the addition of another country location—Country C—that includes a GSM-type cellular system 54, 56, and another pre-paid switching platform 52, account transfer communications link 48, and a localized Country C account database 50.

The basic methodology of the real-time account tracking system is shown in FIG. 3. This figure is a flow chart of a preferred method of transferring call-setup and account information between the distributed databases shown in FIGS. 1 and 2 for a pre-paid wireless communications application. After describing the basic method, several examples will be given with respect to a customer 10 moving within the systems shown in FIGS. 1 and 2.

The method begins as a customer 10 powers-up their cellular phone 60 in a particular country. When this occurs, the phone automatically transmits its MIN and ESN to the nearest MTSO 62. If the phone is an AMPS phone, then the transmission is received by the nearest AMPS MTSO 24, and if the phone is a digital GSM phone, then by the nearest GSM MTSO 28. The relevant MTSO examines the MIN to determine whether the line-range of the MIN is in the MTSO's foreign VLR 64.

If the MIN line-range is not in the foreign VLR, then the MTSO ignores the transmission 66. This occurs when the pre-paid service provider does not have an appropriate contract with the company operating the cellular network (or other service provider) to transport the pre-paid service provider's calls. If the line-range does match with an entry stored in the MTSO foreign VLR, then the MTSO issues a query 68 through the IS-41 or GSM clouds 32, 36 to find the individual customer profile in the HLR. This query is generally based on the MIN/ESN combination of the customer 10. Assuming the appropriate HLR has been contacted by the serving MTSO, a further determination is made as to whether the specific MIN/ESN combination of this customer is present in the HLR 70. If it is not, which can happen for a former customer, or a customer who has not paid their bill, or for a variety of other reasons, then the transmission is ignored 66. But, if the MIN/ESN combination is validated by the HLR 70, then the security, service and configuration information for this customer is copied from the HLR to the serving MTSO 72 so that the MTSO can build a specific temporary VLR entry for this customer that defines the scope of services allowed for the customer.

After the HLR information is copied to the serving MTSO (or at the same time as this operation is commencing), the HLR communicates with the customer's home account database to determine whether the Location Flag is set to the location where the customer is presently located 74. This customer's location is known from information provided by the cellular network, and also by the specific MTSO requesting HLR information for this customer. If the customer location is the same as the Location Flag, then the customer's account record is in the right place, and no transfer of the account record occurs. At this point, the system is ready to process a call to or from the customer 80. (This step will be described in more detail below.)

But if the customer location is different than the location of the customer's account record (as indicated by the Location Flag), then the system must transfer the account record to the present location of the customer 76. So, for example, if the Location Flag indicated that the Customer was in Country A, but the present location of the customer (based on information derived from the communication from the serving MTSO to the HLR) is Country B, then the system will transfer the account record from the Country A account database to the Country B account database via the account transfer communication link. Since the amount of data to transfer is very small, this step takes a few seconds, at most, and only requires a periodic burst of bandwidth. Once the account has been transferred to the new location, the Location Flag is set to indicate the new location of the customer's account 78, and the system is then ready to process a call 80. At the same time that the account is transferred, the appropriate monetary exchange rate can be applied to the account balance so it is in the correct debit currency for the new location.

Consider now an example associated with FIG. 1. Assume that customer 10 has just signed-up for the pre-paid cellular service, and the customer's home location is Country A, the United States. The customer 10 has not left the United States yet. Thus, the customer's account record is stored in the Country A account database 14, which is located in the United States. Assume also that the phone is a GSM phone.

The customer 10 powers-up the phone for the first time. The phone immediately transmits its MIN/ESN (or other identification information) to a nearby GSM cellular tower 30, which couples this transmission to a nearby GSM MTSO 28. The GSM MTSO 28 examines the line-range of the MIN in comparison to its foreign VLR and determines that this MIN range is associated with the pre-paid switching platform 12. So, the MTSO 28 issues a query through the GSM cloud 36 to locate the HLR 18 of this customer 10. The HLR 18 examines the specific MIN/ESN combination of the customer 10 (which is provided by the MTSO) and determines that this is a valid subscriber of the pre-paid cellular system. So, the HLR communicates information back to the MTSO via the GSM cloud 36 such that the MTSO 28 can build a specific VLR entry that defines the services for this customer 10. The VLR entry may also include a “hot-line” command that causes the MTSO 28 to route any calls from the customer 10 to the pre-paid switching platform via an 800 or 888 toll-free number, or some other way.

At about the same time, the HLR communicates with the home database 14 of this customer 10 to determine whether the Location Flag stored at the database 14 is consistent with the current location of the customer 10. In this example, since the customer has not left the United States yet, the customer's account is still stored at the home database 14, and the Location Flag is set to indicate that the account is in the United States database. So, no transfer is necessary, and the system is now ready to process a call.

To make a call using the system, the customer 10 preferably hits the “send” key on the cellular phone, with or without dialing any specific digits. The GSM MTSO identifies the MIN/ESN of the call with the VLR entry previously setup for this customer, and hot-lines the call to the pre-paid switching platform 12 via the PSTN. The pre-paid switching platform 12 then prompts the customer 10 to enter a PIN or account number. Assuming the PIN or account number is valid, the platform 12 then prompts the customer 10 to enter the number to dial. Based on the dialed digits, the call is then rated, and assuming that the customer's account balance is sufficient to support the call, the platform 12 then routes the call to the correct destination by outpulsing the dialed digits to the PSTN. The platform 12 can then track and debit the account balance in real-time, since the call is routed through the pre-paid switching platform 12.

Now assume that the customer gets on a plane and travels to Germany, represented on FIG. 1 as Country B. Once in Germany, the customer 10 powers-up their cellular phone. As in the example above, the phone transmits its MIN/ESN combination to the nearest GSM MTSO 46. Assuming that the pre-paid service provider has an agreement with the German GSM cellular operator, which will be indicated by a corresponding MIN line-range entry in the German MTSO's foreign VLR table, the MTSO 44 will query the HLR 18 through the GSM cloud 36. As before, assuming the specific MIN/ESN combination is present in the HLR, the HLR 18 will copy its profile information for this customer 10 to the VLR of the German GSM MTSO 46.

At the same time, the HLR 18 communicates with the pre-paid switching platform 12 and the United States account database 14 (which is the home database for the customer) to determine whether the Location Flag is set for Germany, the current location of the customer 10. In this case, the Location Flag is still set for the United States, since that is where the customer was last located when its phone was activated. Having determined that there is a mis-match between the Location Flag and the current position of the customer 10, the system then transfers the customer's account from the current location of the account (United States) to the current location of the customer (Germany) by transmitting it via the account transfer communication link 16. As noted above, this link 16 can be a low-bandwidth non-dedicated connection since only a small amount of data is required for transfer, and once the transfer is complete, no additional information needs to be shared between the pre-paid system 38, 40, 42 in Germany, and the home account database 14. After the data is transferred to the German account database 40, the Location Flag in the home database 14 is set to indicate that the account record is now located in Germany, and the system in Germany is now ready to handle communications by the customer 10.

Further consider another example of using this system associated with FIG. 3. In this figure, there are three Countries associated with the system. In practice the system can be used with any number of countries, states, provinces, locations, etc. For example, there may be a separate pre-paid platform in each state, or each part of a country, or a single platform may service more than one country in a situation where the size of the country is relatively small. The number and placement of systems to be linked by the present invention is arbitrary.

So, assume Country A is still the United States, Country B is still Germany, and now Country C is China, and further assume that the customer 10 started out in the United States, as before, and traveled to Germany. The customer's account is stored in the account database 40 in Germany, and the Location Flag associated with the customer's home account database 14 indicates that the account is at the German account database 40.

Now the customer 10 travels from Germany to China. As before, once the customer's handset is powered-up, it will attempt to transmit its MIN/ESN to the nearest GSM MTSO 54. The GSM MTSO 54 in China validates the MIN against the line-range in its foreign VLR, and contacts the HLR 18 via the GSM cloud 36. As before, the HLR verifies the specific MIN/ESN combination, and if verified, transmits the information to the Chinese GSM MTSO 54 in order to construct a VLR entry for this customer 10. The HLR simultaneously contacts the home pre-paid platform and account database 14 to communicate the fact that this customer 10 is now in China. The system examines the Location Flag in comparison to the current location of the customer 10 (China), determines that the account is in the wrong location (Germany), and sends a command to the German pre-paid platform and account database 40 instructing it to transfer the customer account information from Germany to the account database in China 50 via the account transfer communication link 42-20-48. The Location Flag is then set to indicate that this customer's account record is now stored at the account database in China.

These same sequence of steps occur each time the customer travels from one country to the next. The system sets up the VLR in the country where the customer is located, and simultaneously transfers the customer's account record to that country so that the local system can perform real-time account tracking and debiting with no link to the home database or any other system or database. The account entry at the home database keeps track of where the current record is located via the Location Flag.

By implementing the present invention shown and described by the drawing figures, many advantages are provided that are not met by the presently known global real-time account tracking systems. First, the present invention is much more cost-effective than the known systems, primarily because no dedicated links are required to a centralized database to constantly monitor and track the customer's use of the system. In addition, the construction and maintenance of the distributed databases is cheaper than building and maintaining a single fault-tolerant database to service all of the customers no matter where they are located. Second, the present invention only requires low-bandwidth, periodic connections between systems in different countries, whereas the prior systems required dedicated high-bandwidth connections that were prone to failure. With the system of the present invention, the only information that needs to be transported between the pre-paid platforms is the account information, which is transmitted in a short, single burst at the moment the customer 10 enters another country, and no further transmissions are required as long as the customer stays within that jurisdiction. Furthermore, the system of the present invention is less prone to failure, reduces call setup time (since the information required to place a local call is automatically transferred when the user moves to a new location without the user even being aware that anything has happened), and provides for a degree of scalability (or growth) into other countries in a cost effective manner that is not possible with the known systems that require the costly dedicated connection no matter how much traffic is being carried by the system.

Having described in detail the preferred embodiments of the present invention, including the preferred modes of operation, it is to be understood that this operation could be carried out with different elements and steps. This preferred embodiment is presented only by way of example and is not meant to limit the scope of the present invention which is defined by the following claims.

What is claimed:

1. A system for global real-time account tracking in a pre-paid telecommunications environment, comprising:
a plurality of pre-paid switching platforms located in a plurality of different countries;
a plurality of account databases for storing customer account information coupled to the prepaid switching platforms, wherein each account database serves as a home database for customer's that reside in a particular country;
the customer account information including a location flag for indicating the present location of the customer's account information; and
a plurality of account transfer communication links for transferring the customer account information from one of the account databases to another.

2. The system of claim 1, further comprising:
means for comparing the location flag to information indicating the present location of the customer to determine whether to transfer a customer's account information from one of the account databases to another.

3. The system of claim 1, wherein the customer account information further includes: a PIN code for account validation; and the amount of telecommunications time remaining in the customer's pre-paid account.

4. The system of claim 1, wherein the pre-paid telecommunications environment is a wireless environment.

5. The system of claim 4, further comprising:
at least one cellular communications network; and
at least one home location register coupled to the cellular communications network and the pre-paid switching platforms for validating customers.

6. The system of claim 5, wherein the customer account information further includes the mobile identification number (MIN) or electronic serial number (ESN) of the customer's wireless communications device.

7. The system of claim 6, wherein the cellular communications network includes:
means for receiving the MIN or ESN of a customer's wireless communications device; and
means for determining whether the customer should be serviced by the cellular communications network.

8. The system of claim 7, wherein the home location register includes:
means for receiving the MIN or ESN of a customer's wireless communications device from the cellular communications network; and means for validating the customer's account based on the MIN or ESN.

9. The system of claim 8, wherein the home location register includes:
means, responsive to a positive validation from the validating means, for transferring information to the cellular communications network to build a visitor location register (VLR) entry for the validated customer.

10. The system of claim 1, wherein the account transfer communication links are satellite connections.

11. The system of claim 1, wherein the account transfer communication links are low-bandwidth, non-dedicated connections.

12. A system for real-time account tracking, comprising:
a dynamic distributed database system for storing account information, the database system including a plurality of individual databases located in a plurality of geographically dispersed regions, wherein each database serves as a home database for certain accounts;
at least one variable entry for each account that indicates the current location of the account in the distributed database system;
means for determining whether the account is in the correct database; and
means for transferring the account information from one database to another if it is determined that the account is not in the correct database.

13. The system of claim 12, wherein the variable entry for a particular account is maintained by the home database for that account.

14. The system of claim 12, wherein the means for determining further comprises:
means for determining the location of a customer associated with a particular account; and
means for comparing the location of the customer to the variable entry to determine whether the account is stored in the correct database.

15. The system of claim 12, wherein the system is a pre-paid wireless communications system.

16. The system of claim 15, wherein the accounts store at least a PIN code for account validation, and an amount of pre-paid telecommunications time for using the wireless communications system.

17. The system of claim 15, further comprising:
a plurality of pre-paid switching platforms located in the plurality of geographically dispersed regions, wherein the pre-paid switching platforms are coupled to the dynamic distributed database system.

18. The system of claim 14, further comprising:
at least one wireless communications network; and
at least one home location register coupled to the wireless communications network and the pre-paid switching platforms for validating the identify of customers.

19. A method for real-time account tracking in a pre-paid cellular telecommunications system, comprising the steps of:
providing a dynamic distributed database system for storing account information, the database system including a plurality of individual databases located in a plurality of geographically dispersed regions, wherein each database serves as a home database for certain accounts and includes at least one variable entry for each account that indicates the current location of the account in the distributed database system;
determining the location of a pre-paid cellular customer who has an account with the system;
determining whether the customer's account is stored in the correct database; and
transferring the customer's account information from one database to another if it is determined that the account is not in the correct database.

20. The method of claim 19, further comprising the step of modifying the variable entry to indicate a new location of the customer's account information.

21. The method of claim 19, further comprising the steps of:
transmitting identification information from the customer's cellular phone to the pre-paid cellular communications network;
validating the customer's ability to use the network by comparing the identification information with information stored in the customer's account; and
building a service entry in a table associated with the pre-paid cellular communications network to enable the customer to place a call.
